(19) United States
(12) Patent Application Publication
(10) Pub. No.: US 2022/0161287 A1
(43) Pub. Date: May 26, 2022

(54) COATING SYSTEM

(71) Applicant: TOYOTA JIDOSHA KABUSHIKI KAISHA, Toyota-shi (JP)

(72) Inventors: Yuki NAGANUMA, Nagoya-shi (JP); Junya OGAWA, Okazaki-shi (JP); Hidetaka ASANO, Nisshin-shi (JP); Yoshimasa OHTAKE, Handa-shi (JP); Shinji TANI, Miyoshi-shi (JP); Maiko OTSUKA, Toyota-shi (JP); Junya YAMAMOTO, Seto-shi (JP); Toru YOKOTA, Toyota-shi (JP); Asuka KUROKAWA, Nagoya-shi (JP)

(21) Appl. No.: 17/532,690

(22) Filed: Nov. 22, 2021

(30) Foreign Application Priority Data
Nov. 25, 2020 (JP) 2020-194875

(51) Int. Cl. B05B 12/04; B05B 12/14

(52) U.S. Cl. CPC B05B 12/04; B05B 12/14

(57) ABSTRACT

A coating system capable of quickly providing a vehicle coated in color requested by a user. The coating system includes: an input section that receives input of a requested coating color and starting and ending dates of using the vehicle in the requested coating color; a determination section that determines, based on the input requested coating color, whether a plurality of coating colors is requested for the same vehicle; and an instruction section that instructs coating, for a case of a plurality of coating colors not requested, by selecting the corresponding easily strippable coating material, and for a case of a plurality of coating colors requested, by calculating, based on the input starting and ending dates, use order of the vehicle coated in each of the requested coating colors and sequentially selecting the corresponding easily strippable coating materials in the order opposite to the calculated use order.

### CROSS REFERENCE TO RELATED APPLICATIONS

The present application claims priority from Japanese patent application JP 2020-194875 filed on Nov. 25, 2020, the entire content of which is hereby incorporated by reference into this application.

### BACKGROUND

### Technical Field

The present disclosure relates to a coating system, and in particular, a coating system for coating a vehicle selectively using a plurality of easily strippable coating materials in different colors.

### Background Art

For example, JP H06-142604 A discloses a technique of temporarily protecting the painted surface of a painted vehicle during transportation, by forming an easily strippable coating on the painted surface and then stripping it after transportation. The coating includes layers obtained through application of strippable paint using a roller and by spraying.

### SUMMARY

There has recently been an increasing need for providing a vehicle with its color appropriately changed so as to suite various purposes such as car sharing and car leasing. For use in car sharing, for example, the first user may request a vehicle to be coated in blue, and the second and the third users may request the same vehicle to be coated in red and in green, respectively. To address such a need, the vehicle needs to be recoated in accordance with each user request. However, recoating the vehicle each time is time-consuming, which has made it difficult to quickly provide a vehicle coated in a color requested by a user.

The present disclosure has been made in view of such a technical issue, and provides a coating system capable of quickly providing a vehicle coated in a color requested by a user.

The present disclosure provides a coating system for coating a vehicle selectively using a plurality of easily strippable coating materials in different colors, the coating system includes an input section adapted to receive an input of a requested coating color and starting date and ending date of using the vehicle to be coated in the requested coating color, a determination section adapted to determine, on the basis of the input requested coating color, whether the requested coating color for the same vehicle includes a plurality of coating colors, and an instruction section adapted to instruct coating the vehicle, for a case in which the requested coating color is determined as not including a plurality of coating colors, by selecting an easily strippable coating material corresponding to the requested coating color, and for a case in which the requested coating color is determined as including a plurality of coating colors, by calculating a use order of the vehicle to be coated in each of the requested coating colors, on the basis of the starting date and the ending date of using the vehicle that are input, and sequentially selecting the easily strippable coating materials corresponding to the requested coating colors in an order opposite to the calculated use order of the vehicle.

The coating system according to the present disclosure utilizes the easily strippable property of the coating formed of easily strippable coating material. For example, when it is previously identified that the users request a plurality of coating colors for the same vehicle, it is possible to deliver the vehicle with coatings in the respective coating colors layered in the order opposite to the use order of the vehicle by the users. When the first user finishes using the vehicle, the coating is stripped off from the vehicle, and the vehicle coated in a color requested by the next user can be provided to the next user in a timely manner. This can omit the recoating operation as conventionally performed, thereby reducing time until the user receives a vehicle coated in a requested color. As a result, the vehicle coated in a color requested by the user can be quickly provided.

In the coating system according to the present disclosure, the determination section calculates a use period of the vehicle on the basis of the starting date and the ending date of using the vehicle that are input, and compares the calculated use period with a preset threshold to further determine whether the use period is a long term or a short term. When the use period is determined to be the long term, the instruction section may further instruct performing clear coating application to form a clear coating on each of the coatings in the respective coating colors in some embodiments. In this manner, with the clear coating applied onto the vehicle for a long-term use, the weather resistance and chemical resistance of the coating in each coating color can be enhanced.

Further, in the coating system according to the present disclosure, when the use period is determined to be the long term, the determination section further determines whether a protective coating needs to be formed between the adjacent coatings in the respective coating colors. When it is determined necessary to form the protective coating, the instruction section may further instruct performing protective coating application to form the protective coating on the clear coating formed between the adjacent coatings in the respective coating colors. In this manner, the protective coating is used to enhance the weather resistance of the coatings in the respective coating colors, which can reduce the impact of the sunlight irradiation on the coatings, thus preventing deterioration of the tone of color.

The present disclosure provides a coating system capable of quickly providing a vehicle coted in a coating color requested by a user.

### BRIEF DESCRIPTION OF THE DRAWINGS

FIG. 1 is a block diagram of a coating system according to a first embodiment;

FIG. 2 is a flowchart showing processes of the coating system according to the first embodiment; and

FIG. 3 is a flowchart showing processes of the coating system according to a second embodiment.

### DETAILED DESCRIPTION

With reference to the drawings, embodiments of the coating system according to the present disclosure will be described below. In the following description, for example, a “clear coating” and a “protective coating” are occasionally referred to as a “clear layer” and a “protective layer,” respectively. That is, the “coating” is equivalent to the “layer” in meaning.

### First Embodiment

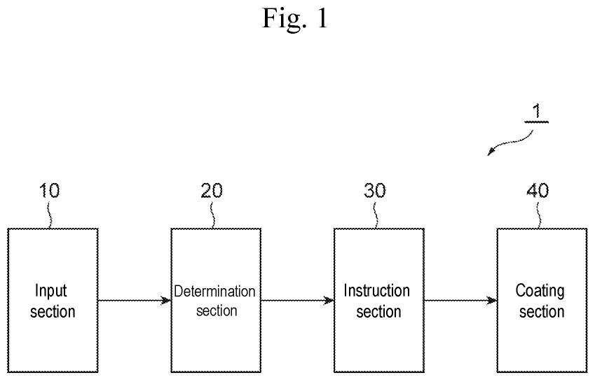

FIG. 1 is a block diagram of a coating system according to a first embodiment. A coating system 1 of the present embodiment is capable of coating a vehicle selectively using a plurality of easily strippable coating materials in different colors as well as performing the typical vehicle coating. It should be noted that the vehicle referred to in the present embodiment includes automobiles and trains.

Further, the typical vehicle coating referred to in the present embodiment includes the coating operation to sequentially form layers such as an electrodeposited layer, an intermediate coating layer, a base layer, and a clear layer on a metal outer panel, for example, a hood panel, and the coating operation to sequentially form layers such as a primer layer, a base layer, and a clear layer on a resin exterior component, for example, a front bumper cover. Furthermore, the easily strippable coating material means a coating material that allows a coating formed of it to have more easily strippable property as compared to a coating formed through the typical vehicle coating. Therefore, the coating formed of such an easily strippable coating material can be referred to as a strippable coating. Examples of the easily strippable coating material include coating materials made from xylene, ethylbenzene, an antioxidant, methyl ethyl ketone, a silica reactant, a titanium oxide (nanoparticles), an organic solvent, and the like.

The coating system 1 of the present embodiment includes a microcomputer with a combination of, for example, a CPU (Central Processing Unit) for executing calculations, a ROM (Read Only Memory) as a secondary storage device in which programs for calculation are recorded, and a RAM (Random Access Memory) as a temporary storage device that stores calculation progress or temporarily controlled variables. The coating system 1 performs calculation, determination, and instruction by executing the recorded programs.

As shown in FIG. 1, the coating system 1 includes an input section 10 that receives an input of data or the like, a determination section 20 that performs processes of determination on the system or the like, an instruction section 30 that instructs coating a vehicle, and a coating section 40 that performs coating operation in accordance with the instruction by the instruction section 30.

The input section 10 includes, for example, a keyboard, a mouse, or a touch panel. The input section 10 is allocated to car dealerships, coating plants, car sharing and car leasing service offering sites, and the like, so as to allow direct inputs by vehicle users, car dealers, plant workers, carsharing service operators, clerks at car leasing service offering sites, and the like. For such a purpose, a plurality of input sections 10 may be provided in some embodiments. Data to be input into the input section 10 includes a coating color requested by a user, starting and ending dates of using the vehicle to be coated in the requested coating color, and the like.

The input section 10 may be physically connected to the determination section 20 or may be communicably connected to the determination section 20 via a network or the like. Thus, the data such as the requested coating color, and the starting and ending dates of using the vehicle to be coated in the requested coating color, which are input into the input section 10, is automatically transmitted to the determination section 20.

The determination section 20 determines, on the basis of the input coating color, whether a plurality of coating colors is requested for the same vehicle. Specifically, when different coating colors are input for the same vehicle, the determination section 20 determines that a plurality of coating colors is requested. Meanwhile, when the coating colors input for the same vehicle do not differ, the determination section 20 determines that a plurality of coating colors is not requested.

Further, the determination section 20 calculates a use period of the vehicle on the basis of the starting and ending dates of using the vehicle that are input, and compares the calculated use period with a preset threshold to determine whether the use period is a long term or a short term. Furthermore, when the use period is determined to be a long term, the determination section 20 determines whether a protective coating needs to be formed between the adjacent coatings in the respective coating colors. The determination section 20 then transmits the determination results to the instruction section 30.

When it is determined that a plurality of coating colors is not requested, the instruction section 30 selects an easily strippable coating material corresponding to the requested coating color to instruct coating the vehicle. Meanwhile, when it is determined that a plurality of coating colors is requested, the instruction section 30 calculates the use order of the vehicle to be coated in each of the requested coating colors, on the basis of the input starting and ending dates of using the vehicle, and sequentially selects the easily strippable coating materials corresponding to the requested coating colors in the order opposite to the calculated use order to instruct coating the vehicle.

Further, when the determination section 20 determines that the use period is a long term, the instruction section 30 instructs performing clear coating application to form a clear coating on each of the coatings in the respective coating colors. Furthermore, when the determination section 20 determines that a protective coating needs to be formed, the instruction section 30 instructs performing protective coating application to form the protective coating on the clear coating formed between the adjacent coatings in the respective coating colors.

The coating section 40 may be configured as an automatic coater or as manual spraying performed by a coating operator. When the coating section 40 is configured as the automatic coater, the instruction section 30 transmits the coating instruction to the coating section 40. Meanwhile, the coating section 40 is configured to be performed as manual spraying by the coating operator, the instruction section 30 displays the coating instruction on a monitor or the like (not shown) to notify the coating operator of the coating instruction. It should be noted that the coating instruction includes information such as sites to be coated and the thickness of the coating to be formed as well as the coating color.

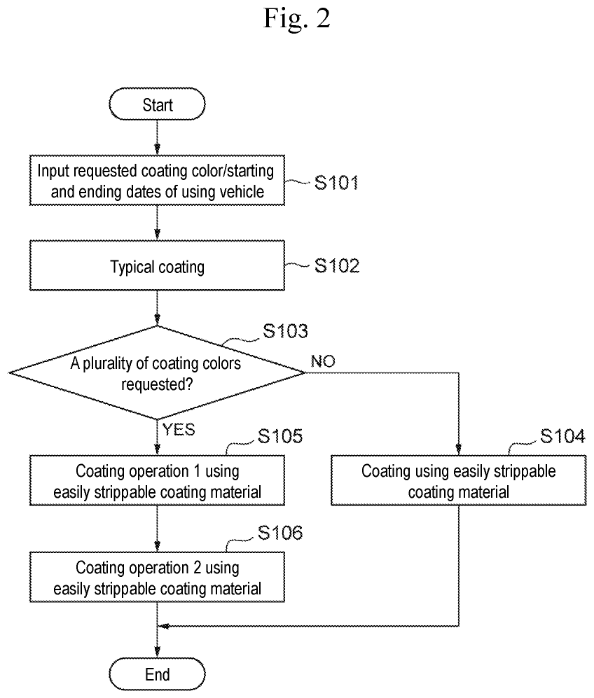

Processes of the coating system 1 will be described below with reference to FIG. 2.

First, in step S101, data on a coating color requested by a user and starting and ending dates of using a vehicle to be coated in the requested coating color is input. As described above, the data may be input into the input section 10 directly by users, or by car dealers, plant workers, car sharing service operators, and clerks at car leasing service offering sites, in place of users.

In step S102 following step S101, the typical vehicle coating is performed. This step performs, for example, the coating operation to sequentially form an electrodeposited layer, an intermediate coating layer, and a base layer on an outer panel of the vehicle, and the coating operation to sequentially form a primer layer and a base layer on a resin exterior component. In the typical vehicle coating, white is set as a body color of the vehicle, for example.

In step S103 following step S102, the determination section 20 obtains data on the coating color requested by the user for the vehicle, which is input into the input section 10, and determines, on the basis of the obtained data, whether a plurality of coating colors is requested for the same vehicle. When the input coating colors do not differ, the determination section 20 determines that a plurality of coating colors is not requested. For example, when a single user inputs red for the same vehicle or when two users each input red, since the requested coating colors do not differ, it is determined that a plurality of coating colors is not requested. Then, the process proceeds to step S104.

In step S104, the instruction section 30 selects an easily strippable coating material corresponding to the coating color input into the input section 10 and instructs coating the vehicle. The coating section 40 performs coating operation on the vehicle using the selected easily strippable coating material in accordance with the coating instruction by the instruction section 30. In the aforementioned example, the easily strippable coating material corresponding to red that is input is selected to be coated on the aforementioned colored body (in white). Then, a drying operation is performed to end a series of processes.

Meanwhile, in step S103, when the coating colors input into the input section 10 differ, the determination section 20 determines that a plurality of coating colors is requested. For example, when a user A uses a vehicle coated in blue and a user B uses the same vehicle coated in green, or a user A uses a vehicle coated in blue first and then the same vehicle coated in green, different coating colors are requested, and thus, it is determined that a plurality of coating colors is requested. Then, the process proceeds to step S105.

In step S105, the instruction section 30 calculates a use order of the vehicle to be coated in each of the requested coating colors, on the basis of the input starting and ending dates of using the vehicle, and sequentially selects the easily strippable coating materials corresponding to the requested coating colors in the order opposite to the calculated use order to instruct coating the vehicle. For example, when a user A uses a vehicle coated in blue for a period between February 15 and March 30, and a user B uses the same vehicle coated in green for a period between May 1 and August 31, or a user A uses a vehicle coated in blue for a period between February 15 and April 15 and uses the same vehicle coated in green for a period between April 16 and June 30, the instruction section 30 calculates the use order of the vehicle coated in blue first, followed by green.

Next, the instruction section 30 selects sequentially the easily strippable coating materials corresponding to the requested coating colors in the order opposite to the calculated use order, that is, green first, followed by blue, and instructs coating the vehicle. Therefore, the easily strippable coating material corresponding to green is first selected and is coated on the aforementioned colored body (in white). That is, as shown in step S105, a coating operation 1 using the easily strippable coating material is performed, and subsequently drying operation is performed. Then, the strippable green coating is formed.

Subsequently, the easily strippable coating material corresponding to blue is selected and is coated on the strippable green coating formed in step S105. That is, as shown in step S106, a coating operation 2 using the easily strippable coating material is performed, and then, drying operation is performed, so that the strippable blue coating is formed. Then, a series of processes ends.

The coating system 1 according to the present disclosure utilizes the easily strippable property of the coating formed of the easily strippable coating material. For example, when it is previously identified that users request a plurality of coating colors for the same vehicle, it is possible to deliver the vehicle with coatings in the respective coating colors layered in the order opposite to the use order of the vehicle by the users. Further, when the first user finishes using the vehicle, the coating is stripped off from the vehicle, and the vehicle coated in a color requested by the next user can be provided to the next user in a timely manner. This can omit the recoating operation as conventionally performed, thereby reducing time until the user receives a vehicle coated in a requested color. As a result, the vehicle coated in a color requested by the user can be quickly provided. Further, since the recoating operation as conventionally performed can be omitted, the cost of the coating operation can be reduced as compared to the conventional coating.

Furthermore, with the coatings in the respective coating colors layered, the effects produced by overlapping coating colors can be expected. For example, the effects of the additive color mixture, such as overlapping red and blue coatings making the color to appear purple, and the subtractive color mixture, such as overlapping yellow and blue coatings making the color to appear green, are utilized to be able to increase variations in the coating colors of the vehicle, as well as to improve the designability of the vehicle.

It should be noted that a vehicle after use (that is, a vehicle with only the body color remaining) can be returned to a coating plant for reuse or can be sold, for example. This can use the vehicle more effectively and reduce the environmental burden.

It should be noted that in the present embodiment, the description has been made by presenting the example of two kinds of coating colors input for the same vehicle. When three or more kinds of coating colors are input, the coating operation using the easily strippable coating materials corresponding to the coating colors may be performed the same number of times as the number of coating colors.

### Second Embodiment

The coating system of the second embodiment is the same as the first embodiment in configuration, but is different in processes. The following will describe only the processes of the coating system of the second embodiment, omitting the same descriptions of the first embodiment.

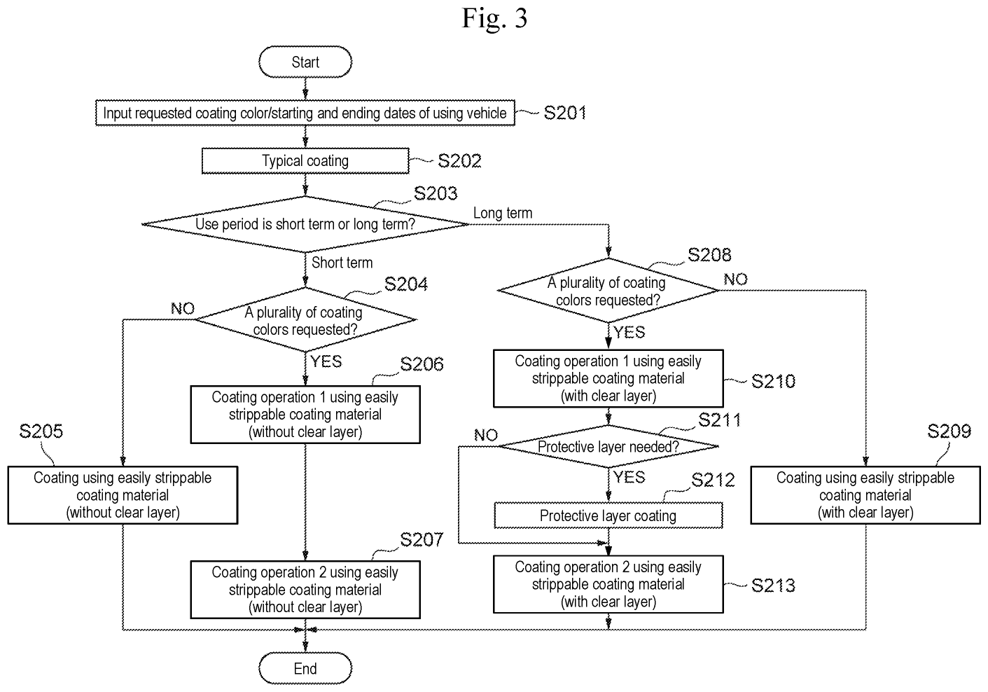

FIG. 3 is a flowchart showing the processes of the coating system according to the second embodiment. First, in step S201, similarly to the aforementioned step S101, data on a requested coating color and starting and ending dates of using a vehicle to be coated in the requested coating color is input. In step S202 following step S201, similarly to the aforementioned step S102, the typical vehicle coating is performed.

In step S203 following step S202, the determination section 20 calculates a use period of the vehicle on the basis of the starting and ending dates of using the vehicle that are input, and compares the calculated use period with a preset threshold to determine whether the use period is a long term or a short term. The threshold herein is set considering the weather condition of the region where the vehicle is to be used, the empirical values of coating deterioration, and the like. The threshold of the present embodiment is set to be three months.

Further, for example, when a user A uses a vehicle for a period between February 1 and March 31 and a user B uses the same vehicle for a period between May 1 and May 31, the determination section 20 calculates the use period of the vehicle by the user A as two months and by the user B as one month, respectively. Next, the determination section 20 compares the calculated results with the threshold (three months). Herein, since the use period (two months) of the vehicle by the user A and the use period (one month) of the vehicle by the user B are both smaller than the threshold, the determination section 20 determines that the use period of the vehicle is a short term. Then, the process proceeds to step S204.

Steps S204 to S207 perform processes similar to those of the aforementioned steps S103 to S106. It should be noted that since the use period of the vehicle is a short term, in the coating processes of steps S205 to S207, the clear coating application to form a clear coating is not performed.

Meanwhile, in step S203, for example, when a user A uses a vehicle for a period between February 1 and June 30 and a user B uses the same vehicle for a period between August 1 and November 30, the determination section 20 calculates the use period of the vehicle by the user A as five months and by the user B as four months. Next, the determination section 20 compares the calculated results with the threshold (three months). Herein, since the use period (five months) of the vehicle by the user A and the use period (four months) of the vehicle by the user B are both greater than the threshold, the determination section 20 determines that the use period of the vehicle is a long term. Then, the process proceeds to step S208.

It should be noted that in step S203, when any of the calculated plurality of use periods is equal to or greater than the threshold, even if the other use periods are smaller than the threshold, the determination section 20 determines that the use period of the vehicle is a long term.

In step S208, similarly to the aforementioned step S103, the determination section 20 obtains data on the requested coating color that is input into the input section 10 and determines, on the basis of the obtained data, whether a plurality of coating colors is requested for the same vehicle. When it is determined that a plurality of coating colors is not requested, the process proceeds to step S209.

In step S209, similarly to the aforementioned step S104, the instruction section 30 selects the easily strippable coating material corresponding to the coating color input into the input section 10 and instructs coating the vehicle, and further, instructs performing the clear coating application to form a clear coating (that is, a clear layer) on the coating in the requested coating color. The coating section 40 performs the coating operation on the vehicle using the selected easily strippable coating material in accordance with the coating instruction by the instruction section 30, and then, further forms the clear coating on the formed strippable coating. Then, the drying operation is performed to end a series of processes.

Meanwhile, in step S208, when different coating colors are input, the determination section 20 determines that a plurality of coating colors is requested. For example, when a user A who uses a vehicle for a period between February 1 and June 30 requests the vehicle coated in blue, and a user B who uses the same vehicle for a period between August 1 and November 30 requests the vehicle coated in green, since the requested coating colors are different, it is determined that a plurality of coating colors is requested. Then, the process proceeds to step S210.

In step S210, similarly to the aforementioned step S105, the instruction section 30 calculates a use order of the vehicle to be coated in each of the requested coating colors, on the basis of the starting and ending dates of using the vehicle that are input, and sequentially selects the easily strippable coating materials corresponding to the requested coating colors in the order opposite to the calculated use order to instruct coating the vehicle. For example, when a user A uses a vehicle coated in blue for a period between February 1 and June 30 and a user B uses the same vehicle coated in green for a period between August 1 and November 30, the instruction section 30 calculates the use order of the vehicle coated in blue first, followed by green.

Next, the instruction section 30 sequentially selects the easily strippable coating materials corresponding to the requested coating colors in the order opposite to the calculated use order, that is, green first, followed by blue, and instructs coating the vehicle. Further, the instruction section 30 instructs performing the clear coating application to form a clear coating on each of the coatings in the respective coating colors.

In accordance with the coating instruction by the instruction section 30, the coating section 40 performs the coating operation on the aforementioned colored body (in white) using the easily strippable coating material corresponding to the first selected green, and then, further performs the clear coating application on the formed strippable green coating (step S210). Then, the drying operation is performed.

In step S211 following step S210, the determination section 20 determines whether a protective coating (that is, a protective layer) needs to be formed between the adjacent coatings in the respective coating colors. Specifically, the determination section 20 determines whether the protective layer needs to be formed between the formed strippable green coating and the strippable blue coating to be formed. The criterion for determining the necessity of forming the protective layer is set considering the length of each use period of the vehicle, the weather condition of the region where the vehicle is to be used, the empirical values of coating deterioration, and the like.

When it is determined unnecessary to form the protective layer, the process proceeds to step S213. Meanwhile, when it is determined necessary to form the protective layer, the instruction section 30 further instructs performing the protective coating application to form the protective coating on the clear coating formed between the adjacent coatings in the respective coating colors. The coating section 40 performs the protective coating application to further form the protective layer on the clear layer (the clear layer formed on the strippable green coating) formed in step S210, in accordance with the instruction for performing the protective coating application to form the protective coating (step S212). The protective layer may be formed in black that absorbs the sunlight in some embodiments, but may be in other colors that reflect or scatter the sunlight.

In step S213 following step S212, the coating section 40 performs the coating operation on the clear layer formed in step S210 or the protective layer formed in step S212 using the easily strippable coating material corresponding to the selected blue in accordance with the coating instruction by the instruction section 30. Then, the coating section 40 further performs the clear coating application on the strippable blue coating formed using the easily strippable coating material. Next, the drying operation is performed. Then, a series of processes ends.

According to the coating system of the present embodiment, in addition to the operational effects similar to those of the aforementioned first embodiment, the following effects are produced. That is, when the use period of a vehicle is determined to be a long term, the clear layer formed on each of the coatings in the respective coating colors can enhance the weather resistance and chemical resistance of each of the coatings in the respective coating colors. Meanwhile, when the use period is determined to be a short term, since the clear layer is not formed, the cost increase due to forming the clear layer can be suppressed.

Further, when it is determined necessary to form a protective layer between the adjacent coatings in the respective coating colors, the formed protective layer can enhance the weather resistance of the coatings in the respective coating colors, so that the impact of the sunlight irradiation on the coatings can be reduced, thereby preventing deterioration of the tone of color. In particular, when red having a high designability is used as the coating color, since organic coating material is used, deterioration likely occurs. The protective layer formed as in the aforementioned manner can prevent the deterioration of the coating, so that the vivid tone of color can be maintained for a long period of time.

Although the embodiments of the present disclosure have been described in detail, the present disclosure is not limited thereto, and various design changes can be made without departing from the spirit of the present disclosure described in the scope of the claims.

What is claimed is:

1. A coating system for coating a vehicle selectively using a plurality of easily strippable coating materials in different colors, the coating system comprising:
an input section adapted to receive an input of a requested coating color and starting date and ending date of using the vehicle to be coated in the requested coating color;
a determination section adapted to determine, on the basis of the input requested coating color, whether the requested coating color for a same vehicle includes a plurality of coating colors; and
an instruction section adapted to instruct coating the vehicle, wherein for a case in which the requested coating color is determined as not including a plurality of coating colors, by selecting an easily strippable coating material corresponding to the requested coating color, and wherein for a case in which the requested coating color is determined as including a plurality of coating colors, by calculating a use order of the vehicle to be coated in each of the requested coating colors, on the basis of the starting date and the ending date of using the vehicle that are input, and sequentially selecting the easily strippable coating materials corresponding to the requested coating colors in an order opposite to the calculated use order of the vehicle.

2. The coating system according to claim 1, wherein
the determination section calculates a use period of the vehicle on the basis of the starting date and the ending date of using the vehicle that are input, and compares the calculated use period with a preset threshold to further determine whether the use period is a long term or a short term, and
when the use period is determined to be the long term, the instruction section further instructs performing clear coating application to form a clear coating on each of the coatings in the respective coating colors.

3. The coating system according to claim 2, wherein
when the use period is determined to be the long term, the determination section further determines whether a protective coating needs to be formed between adjacent coatings in the respective coating colors, and
when it is determined necessary to form the protective coating, the instruction section further instructs performing protective coating application to form the protective coating on the clear coating formed between the adjacent coatings in the respective coating colors.
